(19) United States
(12) Patent Application Publication
(10) Pub. No.: US 2013/0269856 A1
(43) Pub. Date: Oct. 17, 2013

(54) METHOD FOR MANAGEMENT OF WIRES

(71) Applicant: BenTab LLC, New York, NY (US)

(72) Inventor: Terrence M. Bennett, New York, NY (US)

(21) Appl. No.: 13/915,212

(22) Filed: Jun. 11, 2013

Related U.S. Application Data
(62) Division of application No. 12/251,044, filed on Oct. 14, 2008.

(51) Int. Cl. B32B 37/00

(52) U.S. Cl. CPC B32B 37/0076
USPC 156/70

(57) ABSTRACT

A method for management of wires, cords, tubes, or tubing is provided. The method includes providing a unitary strip having adhesive regions at least at opposite ends of a surface of the unitary strip. At least one protective strip covers at least one of said adhesive regions. The unitary strip is made of a material capable of being shaped at least at a location intermediate its ends. The at least one protective strip is peeled off and at least one of said adhesive regions is adhered to a surface so that the wires, cords, tubes, or tubing can freely slide under the unitary strip at the location intermediate its ends.

### CROSS REFERENCE TO RELATED APPLICATION

This application claims the benefit of U.S. Provisional Application No. 60/999,112, filed Oct. 16, 2007, which is incorporated by reference as if fully set forth. This application is a divisional application of U.S. patent application Ser. No. 12/251,044, filed Oct. 14, 2008.

### FIELD OF INVENTION

The present invention relates to supports for cards and the like, and more particularly to a bendable support capable of assuming a bent shape and changing the bent shape to support and display cards as well as a variety of paper and cardboard documents including, among other applications, greeting and display cards.

### BACKGROUND

There are a number of applications wherein it is desirable to provide a card or other paper product with an ability to retain a given orientation in order to enable it to be self-supporting. As one particular application, greeting cards, in their simplest form, are comprised of a single, relatively stiff sheet of paper or cardboard which is typically folded substantially in half to form an outside front cover, an inside front cover, an inside back cover and an outside back cover. The fold line is typically considered to be a “hinge,” with the hinge or fold being sufficiently pliable to allow the card halves joined at the hinge to be moved relative to one another to facilitate observation and reading of any text and/or graphic material on any of the four aforementioned surfaces.

There are a number of applications wherein it is desired to separate the front and back halves of the greeting card to permit at least partial, if not complete, observation of all surfaces of the card. As one example, let it be assumed that it is desirable to open the card about the hinge so that the two halves form an angle on the order of 45°.

Although it is a simple matter to manually spread the two halves of the card so that they form the aforementioned angle about the hinge, the nature of the material of the typical card is such that it does not retain the desired angular orientation, especially, but not only, when the fold or hinge is oriented in a horizontal (as opposed to a vertical) direction.

It is therefore an objective of the present invention to provide a device which readily and easily attaches to a card such as a greeting card and enables the card to assume a given angular orientation of the card halves relative to one another for display or other purposes.

### SUMMARY

The present invention is characterized by comprising a bendable member formed of a relatively thin gauge material capable of retaining any angular position to which it is bent at a location generally intermediate the ends thereof and having means for adhering or affixing said bendable member to a card to retain the card in an angular orientation which is substantially the same as the angular orientation of the bendable member. The bendable member is narrow so as to cover or conceal only a minimal portion of the card to which it is affixed.

The bendable member, in one preferred embodiment, comprises a thin gauge metallic material having the opposite end surfaces thereof provided with adhesive pads or an adhesive coating. A protective strip (or strips) is (are) used to cover the adhesive pads (or coating) to protect the adhesive surfaces and are easily peeled away preparatory to application of the bendable member to a card or other like structure to which the bendable member is affixed. The bendable member with adhesive coating or adhesive pads is also usable in a variety of other applications, use with a greeting card being only one possible application.

### BRIEF DESCRIPTION OF THE DRAWINGS

The above as well as other objectives and embodiments will become apparent upon consideration of the detailed description and drawings wherein like elements are designated by like numerals and wherein:

FIGS. 1 and 1A are top and bottom plan views of a support device embodying the principles of the present invention.

FIG. 1B is a sectional view of one end of the embodiment of FIG. 1 looking in the direction of arrows 1B-1B of FIG. 1.

FIGS. 2 and 2A show different orientations of the combined card and support structure of FIG. 2B.

FIG. 2B is a perspective view showing the embodiment of FIG. 1 mounted for use on a card.

FIGS. 2C, 2D and 2E are lavational views of the support of FIG. 1 employed in different applications.

FIGS. 2F, 2G and 2H are plan views showing different shapes that may be provided for ends of the support.

FIG. 21 is a perspective view of another application for the support of FIG. 1.

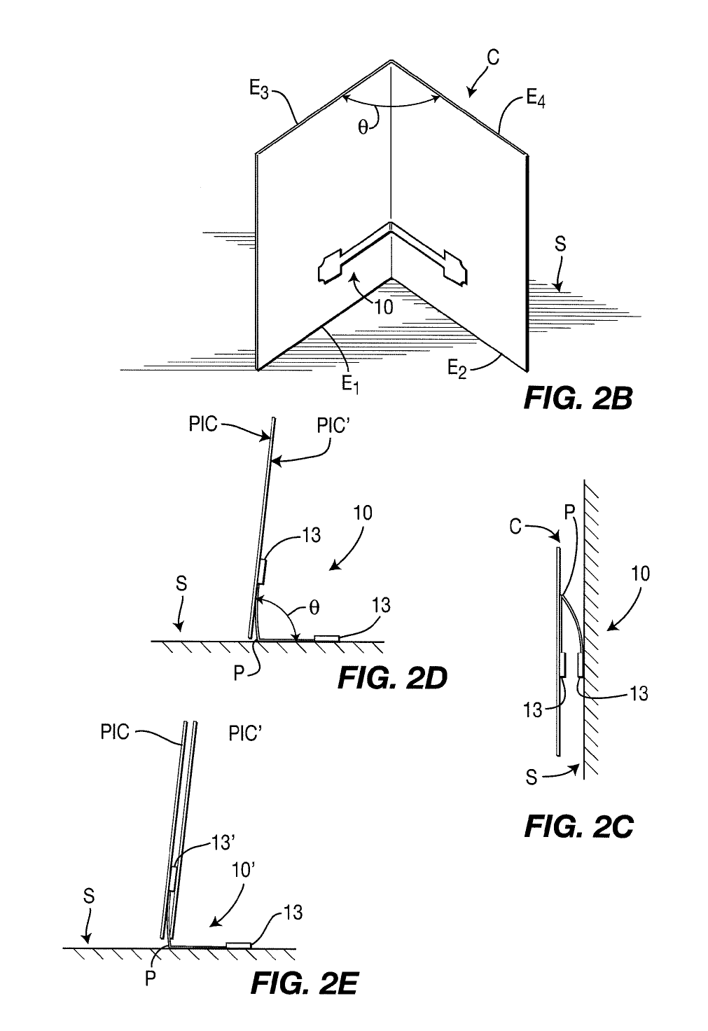

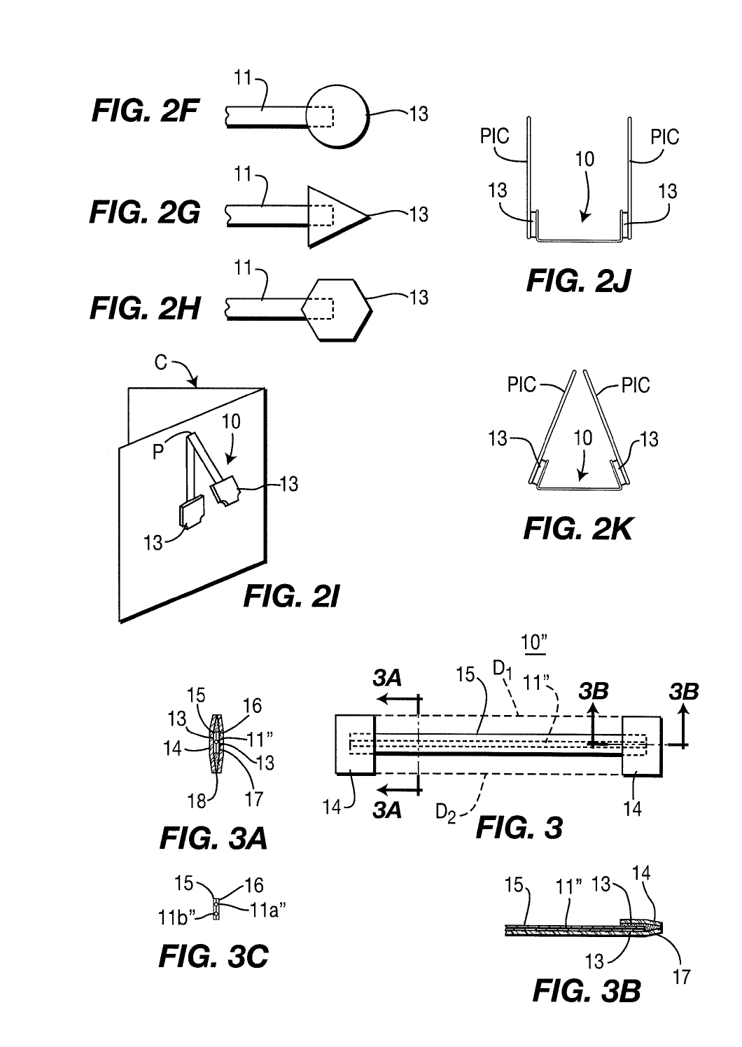

FIGS. 2J and 2K show alternative arrangements for supporting two photographs.

FIGS. 3, 3A and 3B respectively show plan, end and side views of another embodiment of the present invention and FIG. 3C shows as end view of a modification of the embodiment of FIGS. 3-3B.

FIG. 4 is a plan view showing another embodiment of the invention.

FIG. 4A is a partial view of the embodiment of FIG. 4 looking in the direction of arrows 4A-4A of FIG. 4.

FIG. 4B is a perspective view of a hat having a support for use in the embodiment of FIGS. 4 and 4A.

FIGS. 5A and 5B are plan views of another embodiment of the support for holding cord or wire in place, wherein it is used to hold insulated wire or cord in place.

### DETAILED DESCRIPTION OF THE INVENTION

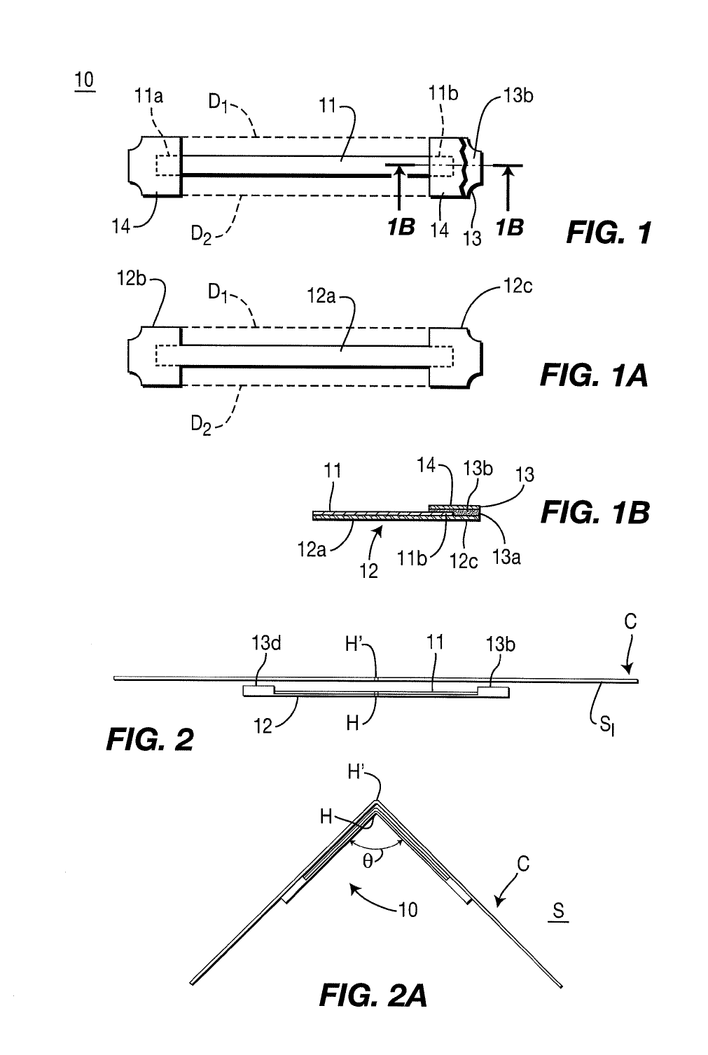

Making reference to FIGS. 1, 1A and 1B, there is shown therein an embodiment 10 comprised of an elongated thin gauge metallic element 11 completely covered on the top surface thereof by a thin paper or cardboard sheet 12 having a central portion 12a of a length and width preferably, but not necessarily, commensurate with the exposed metallic member 11 shown in FIG. 1 and having opposite ends 12b and 12c of enlarged width substantially covering the end portions 11a and 11b of metallic member 11. The paper or thin cardboard sheet 12 is adhered to the metallic member by a suitable adhesive, epoxy, glue or other suitable material. The opposite surface of metallic strip 11 is covered by a layer or sheet-like member 13 having an adhesive quality on both opposing surfaces 13a and 13b thereof. Surface 13a adheres to the surface of metallic member 11 and a portion of the end 12c of cover 12. The opposite adhesive surface 13b of adhesive member 13 is covered with a protective strip 14, a portion of which has been removed in FIG. 1 to expose a portion of the adhesive surface 13b. The left-hand end of embodiment 10 has a similar adhesive member 13 (not shown) and protective cover strip 14 which is identical in design and function to the adhesive member 13 and protective strip 14 provided at the right-hand end of the embodiment 10 and described above. As an alternative, the double-sided adhesive strip may be replaced by an adhesive applied directly to the ends 12b, 12c. Also, the central portion 12a of coversheet 12 may be omitted without reducing the effectiveness of the support 10.

In use, the protective strips 14 are peeled off and the exposed adhesive surfaces 13b, 13d are pressed against surfaces of a card, such as a greeting card C shown in FIG. 2, and bent at or near the middle thereof to form a “hinge” H aligned with the “spine” H¹ of the card C along which the card is bent in half, as is conventional, to provide an outside front cover, an inside front cover, an outside back cover and an inside back cover, the front and back covers being joined to one another at hinge H¹. The support 10 keeps the card from opening or closing.

As an alternative, only one surface need be provided with adhesive or adhesive-like regions for attachment to a card or other like member, the adhesive regions being protected by a protective strip.

The support 10 is preferably aligned along an interior surface Si of card C so that its midpoint is approximately in alignment with the hinge H¹ although this is not an absolute necessity and there is no need for a high degree of precision in making this alignment, since the effectiveness of the support is not diminished if the support is not bent exactly in half. The joined card and support 10 are then bent from the position shown in FIG. 2 to the position shown in FIG. 2A where the card halves as well as the support 10 are bent to define an angle typically on the order of 45° to 90° although an angle of greater than 90° or less than 45° may also be selected. The card C may then be placed upon a surface S as shown in FIG. 2A. The metallic member 11, while being of a thin gauge material enabling it to be easily bent, is nevertheless capable of retaining the desired angular orientation of card C once released from the bending force applied thereto, which bending force is so slight that even a child can bend the support and card with relative ease. The card, whose rigidity is increased due to the support 10, may then be displayed in this manner without concern for a force that may be exerted by card C upon support 10 since the force exerted by the card upon the support is insufficient to alter the angular orientation of support 10. The cover 12 serves as a protective cover to prevent the user from any sharp edges on the opposite longitudinal sides of the exposed portion of metallic member 11.

FIG. 2B shows another orientation of the card C with the support 10 secured thereto, wherein the card is arranged so that its lower edges E1, E2 engage a supporting surface S, the card C standing upright on supporting surface S enabling viewing of both the inside and outside of the front and back covers. Again, the bending angle may be anywhere within or even outside of the range set forth above. The bending angle may be changed simply by holding and bending the card C and/or the support 10.

Support 10 may be provided near the lower edge of card C as shown in FIG. 2B or be arranged near the upper edges E3, E4 of card C or, if desired, may even be provided at a location intermediate the upper and lower edges of the card, although a preferred location is one in which the least amount of text and/or graphics provided within the interior of the card is covered. The narrow width of support 10 also serves to reduce the portion of the card C covered by support 10 to a minimum.

The support may be used for a variety of different applications. Noting FIG. 2C, for example, a support 10 has a left-hand end 13 adhered to an outer surface of card C, such as, for example, the outside back cover of the card C. Support 10 is bent in half about its intermediate point P and its right-hand pressure sensitive surface 13 is adhered to a surface S which may be a wall, a door, a kitchen cabinet or, for example, any type of non-metallic or metallic but non-magnetic bulletin board which is not capable of being punctured by a pin or which is not capable of having a magnetic holder hold a card or paper in place. The surface may be an irregular surface such as a door knob or a rough surface such as a mailbox. The card C in FIG. 2C may also have an additional support 10 along its interior surface to hold it in an open position, as shown in FIG. 2B.

FIG. 2D shows another application wherein the support 10 has its left-hand end 13 adhered to the rear surface PIC of a picture, photograph or index card PIC with the support 10 bent at substantially its intermediate point P, the left-hand pressure sensitive adhesive surface 13 adhering to the rear surface PIC' of picture PIC and the right-hand pressure sensitive adhesive surface 13 adhering to a support surface S such as a desk, table or the like. Alternatively, the right-hand end of support 10 may simply rest on the surface and need not be adhered to the surface. This is also true for the embodiments of FIGS. 2E, 2J and 2K.

In those instances in which the right-hand pressure sensitive adhesive 13 is adhered to surface S, the bending angle of the support 10/card C is not critical and is not depended upon to stably hold the card C in the upright position. In view of the fact that support 10 covers only a minimal amount of the surface to which it adheres, back-to-back pictures or index cards such as PIC and PIC′ shown in FIG. 2E may be supported by a single support 10. The support 10 may be modified to provide pressure sensitive adhesive surfaces on opposite sides of the ends of metallic strip 11 wherein the modified support 10′ shown in FIG. 2E is positioned between two pictures PIC and PIC′ with the double-sided pressure sensitive adhesive surfaces 13′ adhering to the surfaces of the pictures PIC and PIC′. In the arrangement shown in FIG. 2E the bend angle may be 90 degrees, if desired, due to the fact that the right-hand adhesive region 13 adheres to surface S. Depending upon the size of the pictures or other card being supported, a second support 10 or modified support 10′ may be employed to support the card, picture or the like.

FIGS. 2J and 2K other show alternative arrangements for supporting two pictures. The nature of the pressure sensitive adhesive surface is such that it does not permanently adhere to or mar the surface to which it is adhesively attached and is easy to peel off and will not leave an unsightly mark.

Although the embodiment 10 shown in FIGS. 1 through 1B utilizes enlarged pressure sensitive adhesive members, as an alternative, the strip 12 and pressure sensitive adhesive member may be a constant width over the entire length of the structure as shown by the dotted lines D′, D² shown in FIGS. 1 and 1A. This embodiment provides a pressure sensitive surface of significantly increased surface area.

The ends of the support 10 may assume a variety of decorative, aesthetically pleasing shapes such as circular, triangular, hexagonal or any other polygonal shape, and thereby provide a more attractive support which may be festive and chosen to suit a particular occasion. For example, it may be star-shaped or snowflake-like or may provide a shape which follows a particular theme or holiday occasion such as Christmas (in the shape of Santa Claus′ head); Halloween (in the shape of a pumpkin or a witch's head), July 4^{th} (in the shape of the flag and more particularly a waving flag) and the like. Decorative graphics and/or text may be printed on the sheet 12 to suit a particular occasion. In addition, the sheet may be provided with a color or colors appropriate for a particular holiday or theme (red and green for Christmas, for example). In the alternative embodiment described above wherein the metallic strip has an adhesive region or regions on only one surface, the opposite metallic surface may have a color or colors or images or other graphic material painted, printed or otherwise deposited thereon.

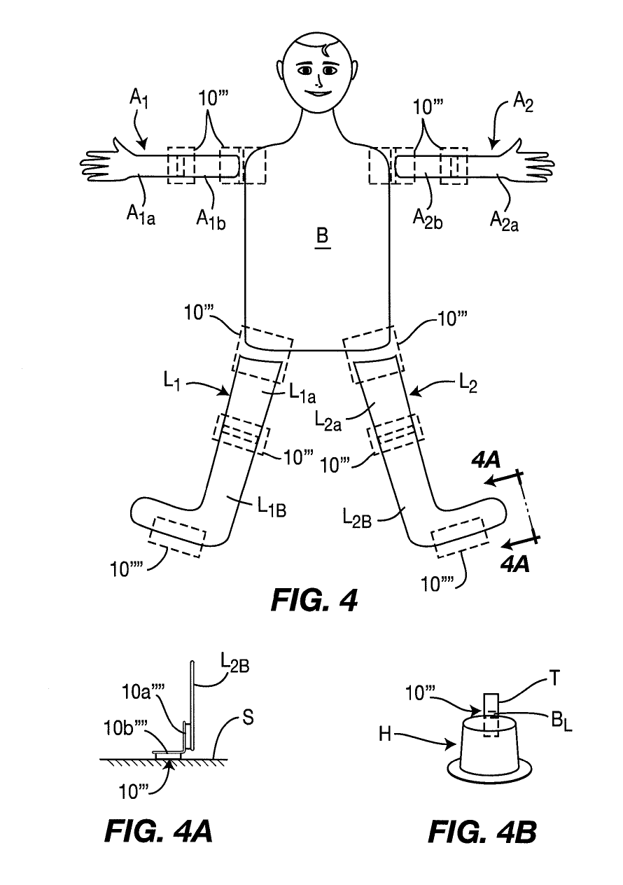

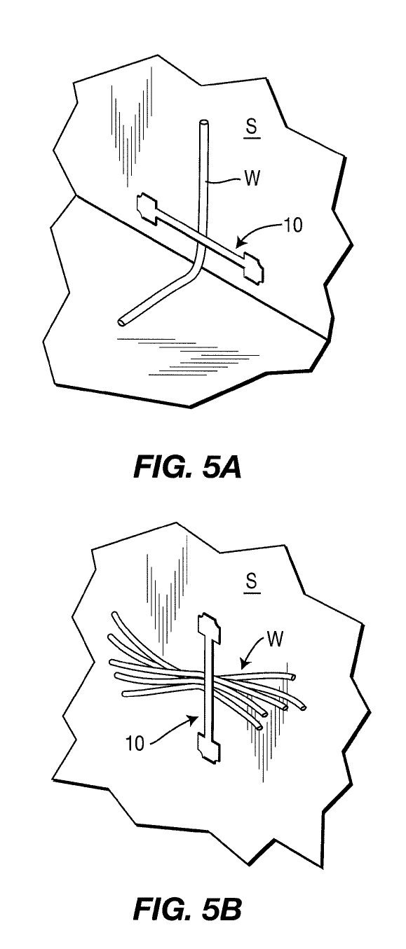

FIG. 21 shows still another manner in which the support 10 may be utilized, support 10 having both of its pressure sensitive adhesives adhered to the outside back cover of a card C or a photo or child's paper project, such as a paper (or cardboard) cutout, which may be human, animal or doll-shaped or other configurations, for example, and bent at substantially its midpoint P, enabling a hook to be placed under the bent portion. As another example, one end of the support may be bent about a branch of a Christmas tree, for example, so as to suspend the card, or other paper object or photo from the tree. As another example, the support may be attached to a card, photograph, or child's paper ornament to form a loop that can be placed around a branch (or branches) of a Christmas tree. An additional support or supports may be provided inside the card to hold the card in the open position, if desired.

As shown in FIGS. 4 and 4A, a paper (or cardboard) item may comprise a body portion B and separate legs L1, L2 and arms A1, A2, each joined to the body portion by one of the supports 10′″ which are shorter in length than the supports of

FIGS. 1 through 3C but otherwise similar in design and function. The supports 10′″ enable the arms and legs to be articulated to the body portion to provide an added dimension of enjoyment to the cutouts. If desired, the arms and legs may each be formed as independent upper and lower arms A1a, A1b, A2a, A2b and legs L1a,L1b, L2a, L2b and articulated to their respective leg/arm portions by supports 10′″. Additional supports 10″″ are provided at the lower ends of each lower leg portion Llb and L2b to enable the cutout to be self-supporting. Noting FIG. 2, support 10″″ is bent in half and has one half 10a″″ attached to leg portion L2b and the other half resting on a support surface S. The surface of half 10b″″ resting upon surface may have an adhesive or adhesive-like surface coating or the like to assure that the cutout is held in an upright manner. As another modification, the legs and arms may be integrally joined to the body and the supports 10′″ may be affixed at locations where legs and arms normally bend/rotate relative to the body such as shoulders, hips, elbows, knees ankles, etc. Also, cutout clothing items may be provided with supports 10′″ to retain the clothing item on the body. FIG. 4B shows a hat H with a tab T which is folded along bend line BL. A support 10′″ is attached to the hat H and bent together with the tab T to securely hold the hat H on the head of the item shown in FIG. 4, for example. It should be understood that the supports 10′″ and 10′″ may be used with a variety of other animate (i.e., animals) or inanimate (i.e., buildings or other the like) forms, limited only by the imagination of the user.

FIGS. 3-3C show still another embodiment 10″ of the present invention in which the bendable metallic member is a wire or wire-like member 11″ imbedded between a pair of sheets 15, 16, as shown in FIG. 3A. An adhesive 18 (or a double-sided adhesive strip) is provided between sheets 15, 16. The ends of the sheets 15, 16 and wire 11″ each have a double-sided pressure sensitive adhesive sheet 13 covered by protective strips 14, 17. The upper surface of the upper pressure sensitive adhesive strip 13 adheres to protective strip 14 and the bottom surface of the lower strip 13 adheres to a cover sheet 17 along the underside of the support 10″. Alternatively, an adhesive may be deposited on the exposed surfaces of the ends of the support. As another alternative, the top and bottom sheets 15 and 16 are made in the form of the ends 13 shown in FIG. 1 so as to have an enlarged width relative to the width of the sheets over the intermediate length of the support 10″. The embodiment 10″ functions in substantially the same manner as the supports 10′ described above in that the wire 11″, while of a relatively thin gauge and capable of being easily bent, is nevertheless able to maintain a card or the like at a desired angle when the bending force applied by the user is removed and thus functions in substantially the same manner as the embodiments of the support described above. If desired, the single wire 11″ embodiment may comprise a pair of wires 11a“, 11b”, shown in FIG. 3C. Alternatively, sheets 15 and 16 may be paper, fiber, cardboard or a fabric and, in still a further alternative, the single wire (or two wires) may be embedded within a pair of sheets as well as being embedded in a suitable plastic which is preferably ejection molded or otherwise extruded to form a flat configuration similar to that shown in FIG. 3A.

As a further alternative, the width of the sheets, 15, 16 or plastic sheet may be increased as shown by dotted lines D¹40 , D² and as an alternative similar to an embodiment described above, the entire surface of one or both sides of the support 10″ may be covered with double-sided pressure sensitive adhesive members to provide a pressure sensitive surface of significantly increased surface area.

The embodiment 10″, like certain embodiments described above, may have end portions of a variety of different shapes of the nature described above. In addition, exposed surfaces, either excluding or including the removable protective strips, may be imprinted with colors, patterns or other arrangements to enhance the attractiveness of the supports.

Briefly reviewing, the applications for the support which are described above, and which are merely representative and should not be considered as in way limiting, include: making a folded greeting card, recipe card or other folded paper item self-supporting, so as to facilitate easy and convenient viewing of the card or paper item, whether the fold thereof is on the side or top; supporting a photograph, postcard or a pair of photographs or postcards back to back so that they can be displayed standing up; attaching origami items, cards or other paper items to a slender support such as Christmas tree branches; hanging notes or papers such as recipes from cabinets such as kitchen cabinets and keeping the bottom corners from bending over or rolling; attaching sheet music to music stands; attaching all sorts of paper items to walls and doors for display; and holding open a page of a document, such as assembly instructions or repair instructions, by holding the top page; and holding a book, or acco-folder or pages open or to a surface to enable the desired page (or pages) to be viewed.

FIGS. 5A and 5B show supports used to hold down or hold in place one or more insulated wires or cords or a combination thereof. FIG. 5A shows a support 10 holding down a wire or cord W on surface S of a floor or wall. The support 10 can have an adhesive coating along its entire length. The center portion may be bent to conform to the shape of the wire or cord, if desired. FIG. 5B shows the support 10 holding down a group of wires or cords W. The wires or cords may be used to power a variety of different devices such as holiday lights and decorations. The wires or cords may couple earpieces to portable devices such as MP3s and the like. The adhesive is preferably of a composition that does not mar the surface to which the support is releasably affixed.

While the invention has been shown and described with reference to preferred embodiments thereof, it will be understood by those skilled in the art that the foregoing and other changes in form and details may be made therein without departing from the spirit and scope of the invention and that certain parts of the invention may be used without other parts.

What is claimed is:

1. A method for management of wires, cords, tubes, or tubing comprising:
providing a unitary strip having adhesive regions at least at opposite ends of a surface of the unitary strip;
at least one protective strip covering said adhesive regions;
said unitary strip being of a material capable of being shaped at least at a location intermediate its ends;
peeling off said at least one protective strip; and
adhering at least one of said adhesive regions to a surface so that the wires, cords, tubes, or tubing can freely slide under the unitary strip at the location intermediate its ends.

2. The method of management of claim 1, wherein the adhesive regions cover the surface of the unitary strip.

3. A method for maintaining a portion of at least one wire, cord, tube, or piece of tubing in a given orientation with respect to a surface, comprising:
providing a strip capable of being shaped at a medial portion to allow the at least one wire, cord, tube, or piece of tubing to freely slide under the medial portion, and an adhesive region at at least one end of the strip;
at least one protective sheet releasably secured to the adhesive region;
peeling off said at least one protective sheet; and
adhering the adhesive region to the surface.

4. The method of claim 3, wherein the strip has opposite ends and the medial portion of the strip is positioned between two adhesive regions located at the opposite ends of the strip.

5. The method of claim 3, wherein a gap is defined between the medial portion of the strip and the surface, and the at least one wire, cord, tube, or piece of tubing is slidable within the gap.

6. The method of claim 3, wherein the medial portion of the strip engages a portion of the at least one wire, cord, tube, or piece of tubing that is adjacent to an end of the at least one wire, cord, tube, or piece of tubing.

7. The method of claim 3, wherein the strip includes a first end and a second end, and the first end and second end matingly engage such that the medial portion of the strip forms a loop for securing the at least one wire, cord, tube, or piece of tubing.
